(19) United States
(12) Patent Application Publication
(10) Pub. No.: US 2015/0115828 A1
(43) Pub. Date: Apr. 30, 2015

(54) LIGHT EMITTING DIODE DRIVING APPARATUS AND LIGHT EMITTING DIODE LIGHTING APPRATUS

(71) Applicant: SAMSUNG ELECTRO-MECHANICS CO., LTD., Suwon-Si (KR)

(72) Inventors: Sang Hyun Cha, Suwon-Si (KR); Hye Jin Lee, Suwon-Si (KR); Deuk Hee Park, Suwon-Si (KR); Yun Joong Lee, Suwon-Si (KR)

(73) Assignee: SAMSUNG ELECTRO-MECHANICS CO., LTD., Suwon-Si (KR)

(21) Appl. No.: 14/327,479

(22) Filed: Jul. 9, 2014

(30) Foreign Application Priority Data
Oct. 31, 2013 (KR) 10-2013-0131562

(51) Int. Cl. H05B 33/08

(52) U.S. Cl. CPC H05B 33/0845
USPC 315/224; 315/291

(57) ABSTRACT

A light emitting diode driving apparatus may include a power supplying unit receiving phase-controlled power and supplying operation power having a preset level, a driving unit receiving the operation power from the power supplying unit to drive a light emitting diode unit receiving the phase-controlled power, and a noise current limiting unit decreasing a noise current due to a parasitic capacitance component of the driving unit.

### CROSS-REFERENCE TO RELATED APPLICATION

This application claims the benefit of Korean Patent Application No. 10-2013-0131562 filed on Oct. 31, 2013, with the Korean Intellectual Property Office, the disclosure of which is incorporated in its entirety herein by reference.

### BACKGROUND

The present disclosure relates to a light emitting diode driving apparatus, for example, but not limited to, to a light emitting diode lighting apparatus using a dimmer controlling a phase of alternating current (AC) power.

A light emitting diode (LED), a semiconductor device formed to have a p-n junction structure and emitting light through the recombination of electrons and holes has recently been applied to various fields in accordance with the development of a semiconductor technology.

Particularly, since LEDs have higher efficiency, longer lifespans and are more environmentally-friendly as compared to existing light emitting apparatuses, fields in which LEDs are applied have continuously increased.

Generally, LEDs may be driven with a direct current (DC) power level of several volts applied thereto due to a structure thereof. Therefore, generally, in order to drive the LED with commercial alternating current (AC) power used domestically, commercially, industrially, or the like, a separate means is required.

In order to drive the LED with commercial AC power, an LED driving apparatus generally includes a rectifying circuit, an AC to DC converter, and the like.

In the case in which the LED driving apparatus uses a DC power, a circuit for providing the DC power becomes complicated.

Therefore, a method of directly using a power generated by rectifying AC power to drive the LED has been suggested.

Meanwhile, a lighting apparatus using LEDs uses a dimmer controlling light emissions of LEDs by converting the AC power, depending on a dimming signal. The dimmer may control light emissions of LEDs by controlling a phase of the AC power.

In LED driving apparatus, particularly, the lighting apparatus using the LED, a pulse current having a significantly high level may be generated in a period in which input power rises due to dimming by the phase control, which applies stress to the dimmer and the light emitting diode to have an influence on reliability.

### RELATED ART DOCUMENT

### (Patent Document 1) Japanese Patent Laid-Open Publication No. 2011-113958

### (Patent Document 2) Japanese Patent Laid-Open Publication No. 2011-124163

### SUMMARY

An aspect of the present disclosure may provide a light emitting diode driving apparatus and a light emitting diode lighting apparatus capable of limiting a noise current generated due to a power by a phase control of a dimmer.

According to an aspect of the present disclosure, a light emitting diode driving apparatus may include: a power supplying unit receiving phase-controlled power and supplying operation power having a preset level; a driving unit receiving the operation power from the power supplying unit to drive a light emitting diode unit receiving the phase-controlled power; and a noise current limiting unit decreasing a noise current due to a parasitic capacitance component of the driving unit.

The noise current limiting unit may suppress an increase in a voltage level of the operation power supplied to the driving unit, due to the phase-controlled power.

The driving unit may include: a switching unit switching a path of a current flowing to the light emitting diode unit; and a driving controlling unit receiving the operation power and comparing a level of detection voltage at which a current flowing to a light emitting diode by conduction of the switching unit is detected and a level of a preset reference voltage with each other to control driving of the switching unit.

The noise current limiting unit may limit a current flowing to a parasitic capacitor of the switching unit to suppress an increase in a voltage level of the operation power supplied to the driving unit.

The noise current limiting unit may include a noise current limiting switch connected between the light emitting diode and the driving unit and conducted by receiving a predetermined power input from the power supplying unit to a gate thereof.

The noise current limiting unit may provide a conduction path of a noise current due to a parasitic capacitance of the noise current limiting switch.

The noise current limiting unit may provide the noise current due to the parasitic capacitance of the noise current limiting switch to the power supplying unit.

The noise current limiting unit may include: a noise current limiting switch connected between the light emitting diode and the driving unit; and a limitation driving controlling unit receiving the operation power and comparing the detection voltage at which the current flowing to the light emitting diode by the conduction of the switching unit is detected and the preset reference voltage with each other to control driving of the noise current limiting switch.

A conduction period of the noise current limiting switch may be equal to or longer than a conduction period of the switching unit.

According to another aspect of the present disclosure, a light emitting diode lighting apparatus may include: a dimmer controlling a phase of alternating current (AC) power; a power supplying unit receiving the phase-controlled power from the dimmer and supplying operation power having a preset level; a driving unit receiving the operation power from the power supplying unit to drive a light emitting diode unit receiving the phase-controlled power; and a noise current limiting unit decreasing a noise current due to a parasitic capacitance component of the driving unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic circuit diagram showing a light emitting diode driving apparatus or a light emitting diode lighting apparatus according to an exemplary embodiment of the present disclosure;

FIG. 2 is a graph showing a cause of a noise current;

FIG. 3 is a schematic circuit diagram showing the light emitting diode driving apparatus from which a noise current limiting unit is omitted;

FIG. 4 is a view showing a detailed configuration of a noise current limiting unit 140 according to an exemplary embodiment of the present disclosure;

FIG. 5 is a view showing a detailed configuration of a noise current limiting unit 140 according to another exemplary embodiment of the present disclosure;

FIG. 6 is a view showing a detailed configuration of a noise current limiting unit 140 according to another exemplary embodiment of the present disclosure; and

FIGS. 7A and 7B are graphs showing an example of a conduction period of a noise current limiting switch and a conduction period of a switch.

### DETAILED DESCRIPTION

Exemplary embodiments of the present disclosure will now be described in detail with reference to the accompanying drawings. The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Throughout the drawings, the same reference numerals will be used throughout to designate the same or like elements.

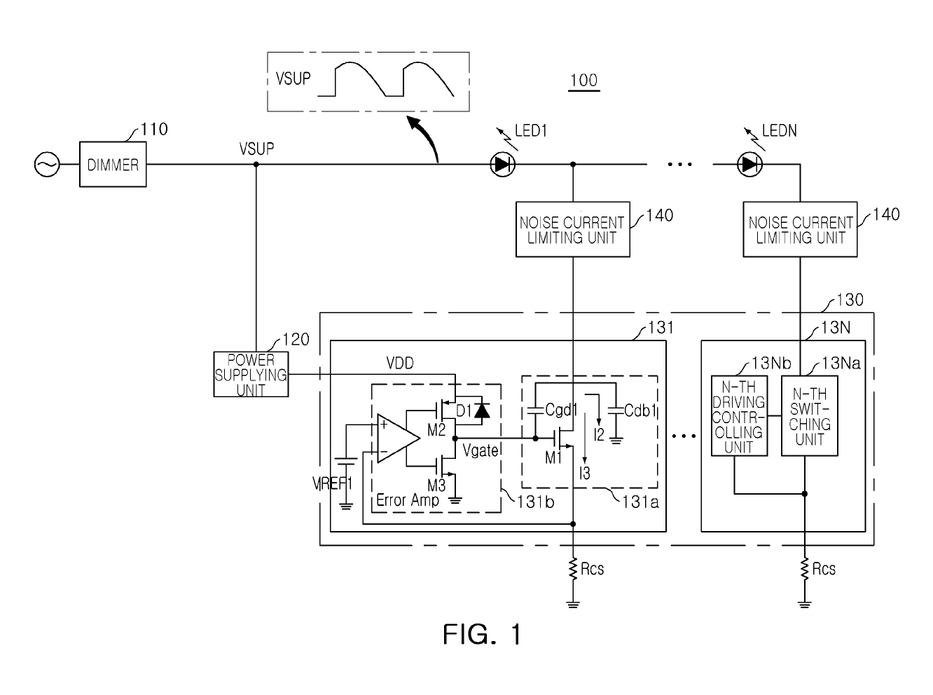

FIG. 1 is a schematic circuit diagram showing a light emitting diode driving apparatus or a light emitting diode lighting apparatus according to an exemplary embodiment of the present disclosure.

Referring to FIG. 1, a light emitting diode driving apparatus or a light emitting diode lighting apparatus 100 according to an exemplary embodiment of the present disclosure may include a power supplying unit 120, a driving unit 130, a noise current limiting unit 140, and a dimmer 110. The dimmer 100 may control a phase of alternating current (AC) power and providing a rectified power. As the dimmer 110, a phase-cut dimmer such as a triac dimmer controlling the phase of the AC power may be used. A detailed description of the dimmer 110 would be apparent to one skill in the art. The LED driving apparatus according to an exemplary embodiment of the present disclosure will be described in detail.

The light emitting diode driving apparatus 100 according to an exemplary embodiment of the present disclosure may include the power supplying unit 120, the driving unit 130, and the noise current limiting unit 140. Here, the power supplying unit 120 may receive phase-controlled power from the dimmer 110, convert the received power into a operation power used to drive the driving unit 130, and then supply the operation power to the driving unit 130.

The driving unit 130 may include first to N-th drivers 131 to 13N. The first to N-th drivers 131 to 13N may include switching units 131a to 13Na and driving controlling units 131b to 13Nb, respectively.

The first to N-th drivers 131 to 13N may drive light emitting diodes, respectively. For example, a light emitting diode unit may include at least one light emitting diode, preferably, a light emitting diode array having a plurality of light emitting diodes connected in series with each other, and first to N-th light emitting diodes LED1 to LEDN of the light emitting diode array may be driven by the first to N-th drivers 131 to 13N corresponding thereto, respectively. For example, when a voltage level of the power phase-controlled by the dimmer 110 is equal to or larger than a voltage level capable of turning on the first light emitting diode LED1, the first light emitting diode LED1 may be first turned on. At the same time, the first driver 131 may drive the first light emitting diode LED1 so that an appropriate current flows to the first light emitting diode LED1.

The first to N light emitting diodes LED1 to LEDN may be sequentially turned on depending on the voltage level of the phase-controlled power, and corresponding drivers of the first to N-th drivers 131 to 13N may drive corresponding light emitting diodes, respectively. In a period in which the voltage level of the phase-controlled power drops from a maximum voltage, the N-th to first light emitting diodes LEDN to LED1 may be sequentially turned off. Therefore, similarly, corresponding drivers of the first to N-th drivers 131 to 13N may drive corresponding light emitting diodes, respectively.

To this end, the first to N-th drivers 131 to 13N may include switching units 131a to 13Na and driving controlling units 131b to 13Nb, respectively. The switching units 131a to 13Na may include at least one switch M1 and may connect between a cathode of a corresponding light emitting diode and a ground, respectively. More specifically, a detection resistor Rcs for detecting a current flowing to the light emitting diode may connect between the switch M1 and the ground.

Each of the driving controlling units 131b to 13Nb may include a comparator comparing a voltage detected by the detection resistor Rcs and a level of a preset reference voltage VREF1 with each other and inverters M2 and M3 receiving a operation power to invert an output of the comparator.

The inverters M2 and M3 may include a P-channel metal oxide semiconductor (PMOS) switch M2 and an N-channel MOS (NMOS) switch M3. The PMOS switch M2 may have a source receiving a operation power VDD from the power supplying unit 120 and a drain connected to a drain of the NMOS switch M3 and the NMOS switch M3 may have a source connected to the ground. The output of the comparator may be provided to gates of the PMOS switch M2 and the NMOS switch M3. Therefore, when the output signal of the comparator is in a high level, the NMOS switch M3 may be turned on, such that an output voltage may become a voltage level of the ground, and when the output signal of the comparator is in a low level, the PMOS switch M2 may be turned on, such that the output voltage may become a voltage level of the operation power.

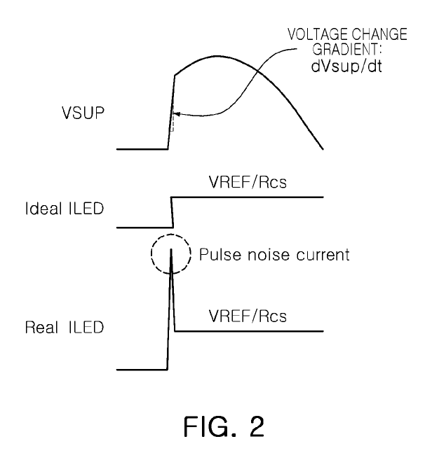

Meanwhile, FIG. 2 is a graph showing a cause of a noise current.

Referring to FIG. 2, ideally, the current flowing to the light emitting diode may stepwise rise from ‘0’ to a driving level VREF/Rcs. However, realistically, due to a waveform of the phase-controlled power VSUP from the dimmer 110, a pulse noise current may be generated by a gradient (dVsup/dt) of the waveform of the power by the phase control.

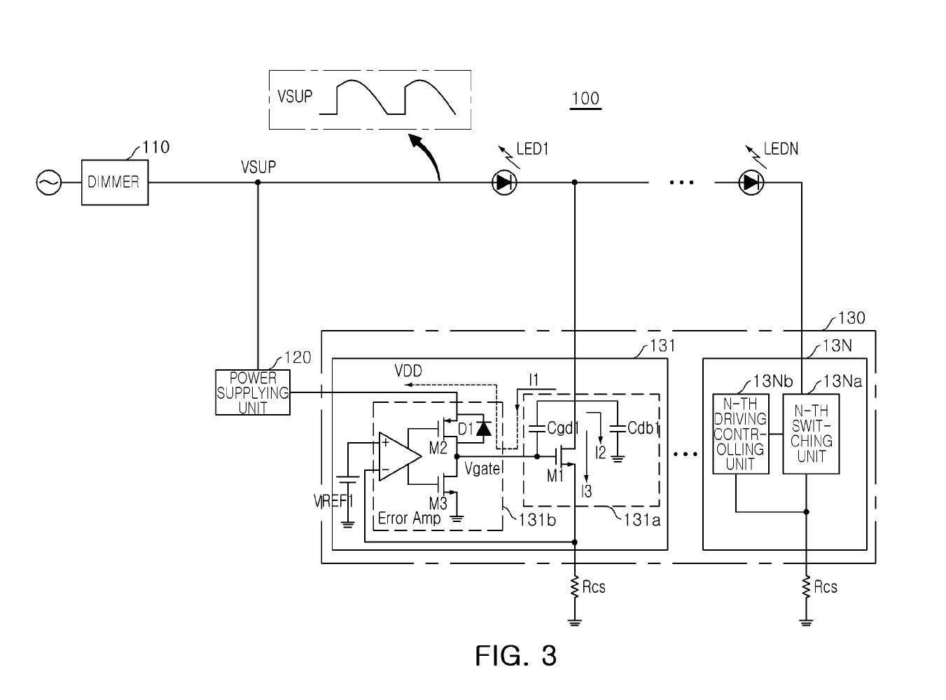

FIG. 3 is a schematic circuit diagram showing the light emitting diode driving apparatus which does not include a noise current limiting unit.

This will be described in detail with reference to FIGS. 2 and 3. The switch M1 of the switching unit 131a may have a parasitic capacitance Cgd1 between a drain and a gate thereof and a parasitic capacitance Cdb1 between the drain and a body thereof. In the case in which the waveform of the phase-controlled power VSUP rises at a gradient dVsup/dt as shown, displacement currents (or noise currents) may be generated in the respective parasitic capacitances, and magnitudes of the respective displacement currents may be predicted as represented by the following Equation 1.

I1=Cdg1*dVsup/dt

I2=Cdb2*dVsup/dt (Equation 1)

Since the displacement currents I1 and I2 due to the respective parasitic capacitances are due to the switch formed of a metal oxide semiconductor field effect transistor (MOSFET), it may be difficult to remove the displacement currents I1 and I2 according to characteristics of the switch.

Meanwhile, when the displacement current I1 due to the parasitic capacitance Cgd1 between the drain and the gate of the switch is generated, a portion of the displacement current I1 may be recovered as the operation power VDD through a parasitic diode D1 of the PMOS switch M2 of the driving controlling unit 131b.

The operation power VDD is not normally controlled in a short time in which the power supplying unit 120 is not normally operated immediately after the voltage level of the phase-controlled power VSUP rapidly rises, such that the voltage level may rise by the displacement current I1 due to the parasitic capacitance Cgd1 between the drain and the gate of the switch. As a result, a voltage level of a gate voltage Vgate applied to the switch M1 rises by the sum of a voltage level of the operation power VDD and a diode drop voltage of the parasitic diode D1 of the PMOS switch M2, such that the switch M1 may be conducted. Therefore, an undesired current I3 may flow, such that impact may be applied to a corresponding light emitting diode.

In order to prevent the phenomenon as described above, the noise current limiting unit 140 may suppress generation of the displacement current I1 due to the parasitic capacitance Cgd1. That is, the noise current limiting unit 140 may decrease the displacement current I1 due to the parasitic capacitance Cgd1. In addition, the noise current limiting unit 140 may suppress an increase in the voltage level of the operation power supplied to the driving unit 131.

That is, the noise current limiting unit 140 may suppress the generation of the displacement current I1 due to the parasitic capacitance Cgd1 at a point in time at which the voltage level of the phase-controlled power VSUP rapidly rises.

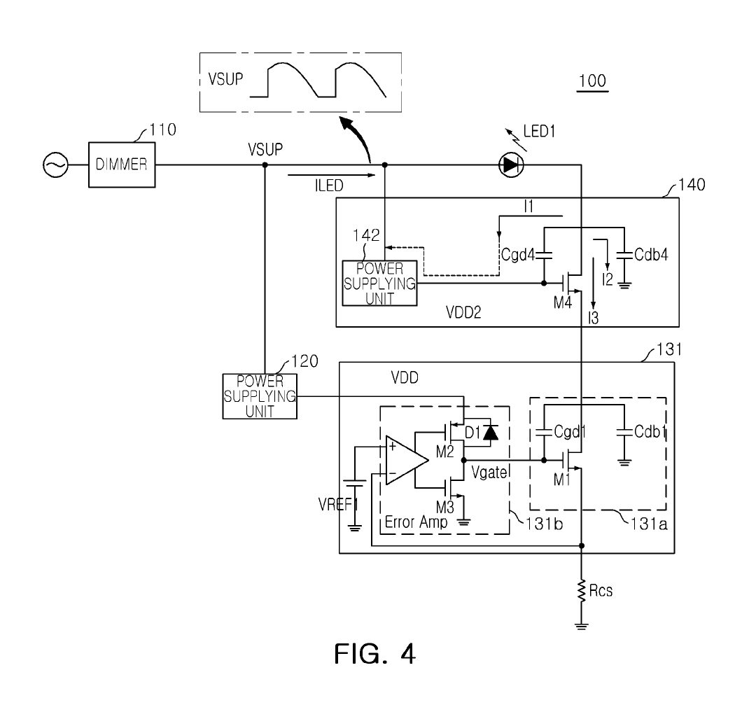

FIG. 4 is a view showing a detailed configuration of a noise current limiting unit 140 according to an exemplary embodiment of the present disclosure.

Referring to FIG. 4, the noise current limiting unit 140 may include a noise current limiting switch M4 and a power supplying unit 142.

The power supplying unit 142 may receive the phase-controlled power from the dimmer 110, convert the phase-controlled power into a operation power used to drive the noise current limiting switch M4, and supply the operation power to the noise current limiting switch M4.

The noise current limiting switch M4 may be connected between the light emitting diode LED1 and the driver 131. In addition, the noise current limiting switch M4 may be implemented by an NMOS switch. A gate of the noise current limiting switch M4 may be connected to the power supplying unit 142. The power supplying unit 142 may apply a predetermined power VDD2 to the gate of the noise current limiting switch M4 to conduct the noise current limiting switch M4.

In a normal state, the power supplying unit 142 may apply the predetermined power VDD2 to the gate of the noise current limiting switch M4 to maintain the noise current limiting switch M4 in a conduction state. Therefore, the light emitting diode LED1 may be controlled by the switching unit 131a.

Meanwhile, the noise current limiting switch M4 may have a parasitic capacitance Cgd4 between a drain and a gate thereof and a parasitic capacitance Cdb4 between the drain and a body thereof. In the case in which the waveform of the phase-controlled power VSUP rises at a predetermined gradient dVsup/dt, displacement currents I1 and I2 may be generated in the respective parasitic capacitances.

Meanwhile, when the displacement current I1 is generated due to the parasitic capacitance Cgd4 between the drain and the gate of the noise current limiting switch M4, a portion of the displacement current may be recovered as the operation power VDD2.

That is, the noise current limiting unit 140 may provide a noise current conduction path from the parasitic capacitance Cgd4 between the drain and the gate of the noise current limiting switch M4 to the power supplying unit 142.

In the case in which the operation power VDD2 rises, the noise current limiting switch M4 may be conducted. However, a gate voltage of the switching unit 131a may not rise. Therefore, the switching unit 131a may not be conducted, such that generation of an undesired current I3 flowing to the switching unit 131a may be suppressed.

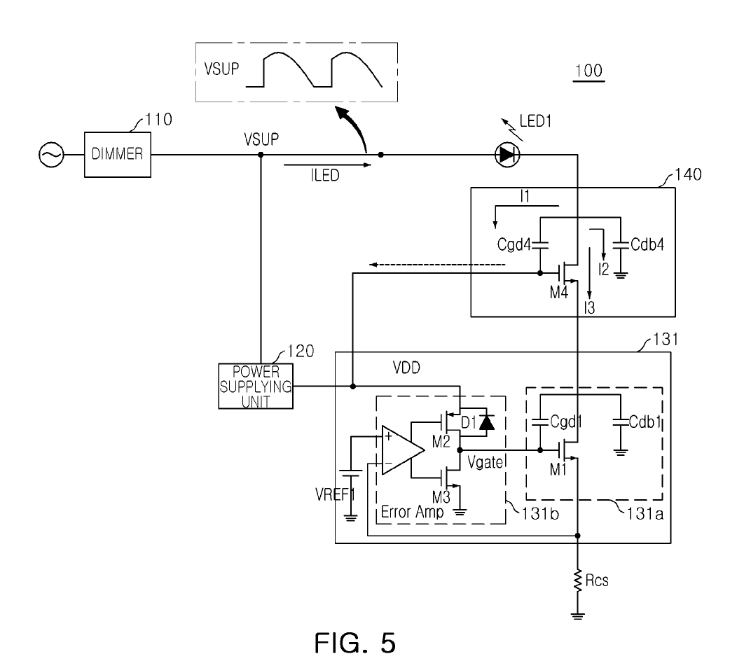

FIG. 5 is a view showing a detailed configuration of a noise current limiting unit 140 according to another exemplary embodiment of the present disclosure.

Referring to FIG. 5, the power supplying unit 142 of FIG. 4 may be omitted, and a gate of the noise current limiting switch M4 may be connected to the power supplying unit 120.

As described above, the noise current limiting switch M4 may have a parasitic capacitance Cgd4 between a drain and a gate thereof and a parasitic capacitance Cdb4 between the drain and a body thereof. In the case in which the waveform of the phase-controlled power VSUP rises at a predetermined gradient dVsup/dt, displacement currents I1 and I2 may be generated in the respective parasitic capacitances.

When the displacement current I1 is generated due to the parasitic capacitance Cgd4 between the drain and the gate of the noise current limiting switch M4, a portion of the displacement current may be recovered as the operation power VDD.

Meanwhile, the displacement current I1 may be an instantaneous current, and a time delay may occur due to the parasitic capacitance Cgd4, or the like. Therefore, the noise current limiting switch M4 is turned on, and a level of the operation power VDD rises, such that an amount of the displacement current I1 is decreased before the switching unit 131a is turned on, whereby generation of an undesired current I3 flowing to the switching unit 131a may be suppressed.

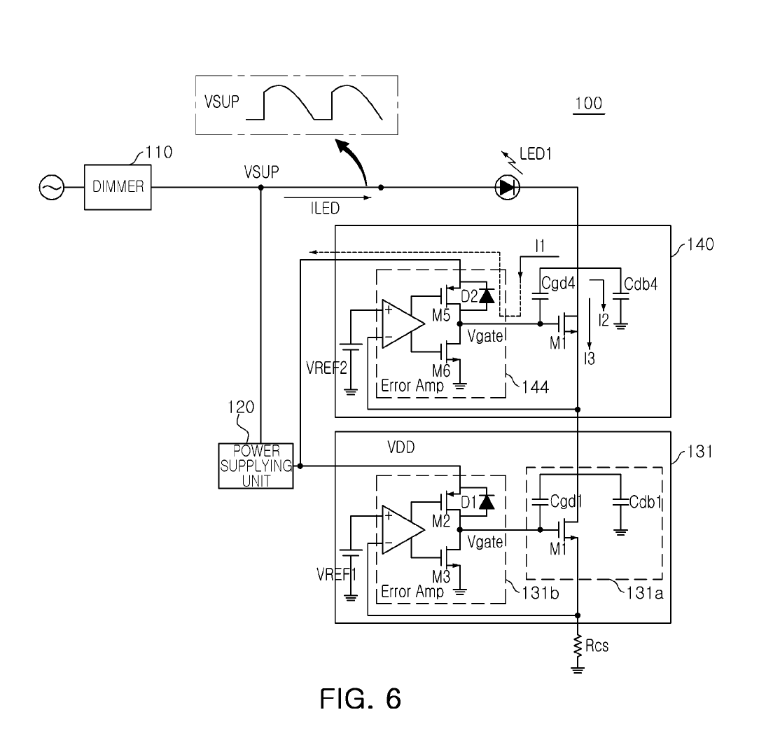

FIG. 6 is a view showing a detailed configuration of a noise current limiting unit 140 according to another exemplary embodiment of the present disclosure.

Referring to FIG. 6, the noise current limiting unit 140 may include a noise current limiting switch M4 and a limitation driving controlling unit 144.

The noise current limiting switch M4 may be connected between the light emitting diode LED1 and the driver 131.

The limitation driving controlling unit 144 may include a comparator comparing a voltage detected by the detection resistor Rcs and a level of a preset reference voltage VREF2 with each other and inverters M5 and M6 receiving a operation power to invert an output of the comparator.

The inverters M5 and M6 may include a p-channel metal oxide semiconductor (PMOS) switch M5 and an n-channel MOS (NMOS) switch M6. The PMOS switch M5 may have a source receiving a operation power VDD from the power supplying unit 120 and a drain connected to a drain of the NMOS switch M6 and the NMOS switch M6 may have a source connected to the ground. The output of the comparator may be provided to gates of the PMOS switch M5 and the NMOS switch M6. Therefore, when the output signal of the comparator is in a high level, the NMOS switch M6 may be turned on, such that an output voltage may become a voltage level of the ground, and when the output signal of the comparator is in a low level, the PMOS switch M5 may be turned on, such that the output voltage may become a voltage level of the operation power.

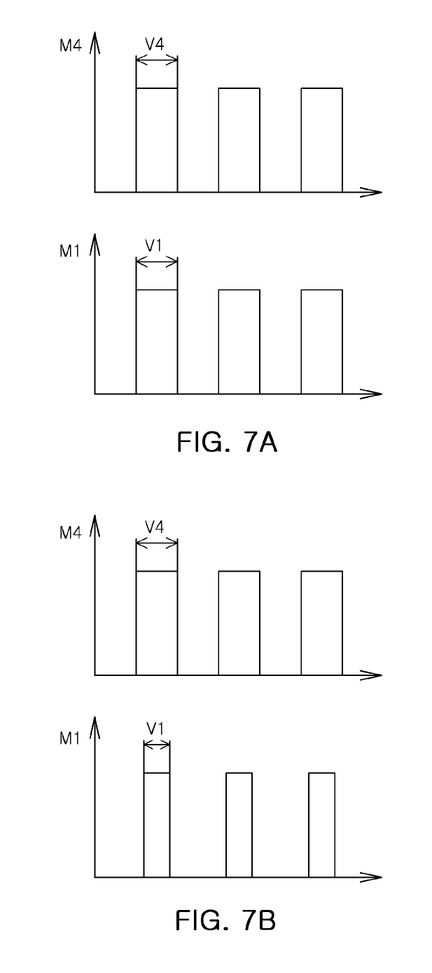

FIGS. 7A and 7B are graphs showing an example of a conduction period of a noise current limiting switch and a conduction period of a switch.

Meanwhile, the conduction period V4 of the noise current limiting switch M4 may be the same as the conduction period V1 of the switch M1 (See FIG. 7A). Alternatively, the conduction period V4 of the noise current limiting switch M4 may be larger than as the conduction period V1 of the switch M1 (See FIG. 7B).

As described above, the noise current limiting switch M4 may have a parasitic capacitance Cgd4 between a drain and a gate thereof and a parasitic capacitance Cdb4 between the drain and a body thereof. In the case in which the waveform of the phase-controlled power VSUP rises at a predetermined gradient dVsup/dt, displacement currents I1 and I2 may be generated in the respective parasitic capacitances.

When the displacement current I1 is generated due to the parasitic capacitance Cgd4 between the drain and the gate of the noise current limiting switch M4, a portion of the displacement current may be recovered as the operation power VDD.

Meanwhile, the displacement current I1 may be an instantaneous current, and a time delay may occur due to the parasitic capacitance Cgd4, or the like. Therefore, the noise current limiting switch M4 is turned on, and a level of the operation power VDD rises, such that an amount of the displacement current I1 is decreased before the switching unit 131a is turned on, whereby generation of an undesired current I3 flowing to the switching unit 131a may be suppressed.

As described above, the noise current limiting unit may suppress the generation of the displacement current due to the parasitic capacitance component Cgd1 of the switching unit 131a and may effectively suppress an increase in the gate voltage of the switch M1.

As set forth above, according to exemplary embodiments of the present disclosure, the noise current generated due to the power by the phase control of the dimmer is limited, whereby reliability of the light emitting diode and the dimmer may be improved.

While exemplary embodiments have been shown and described above, it will be apparent to those skilled in the art that modifications and variations could be made without departing from the spirit and scope of the present disclosure as defined by the appended claims.

What is claimed is:

1. A light emitting diode driving apparatus comprising:
a power supplying unit receiving phase-controlled power and supplying operation power;
a driving unit receiving the operation power to drive a light emitting diode unit receiving the phase-controlled power; and
a noise current limiting unit reducing a noise current generated due to a parasitic capacitance component of the driving unit.

2. The light emitting diode driving apparatus of claim 1, wherein the noise current limiting unit suppresses an increase in a voltage level of the operation power supplied to the driving unit, due to the phase-controlled power.

3. The light emitting diode driving apparatus of claim 1, wherein the driving unit includes:
a switching unit switching a path of a current flowing to the light emitting diode unit; and
a driving controlling unit receiving the operation power and comparing a level of detection voltage at which a current flowing to a light emitting diode by conduction of the switching unit is detected and a level of a preset reference voltage with each other to control driving of the switching unit.

4. The light emitting diode driving apparatus of claim 3, wherein the noise current limiting unit limits a current flowing to a parasitic capacitor of the switching unit to suppress an increase in a voltage level of the operation power supplied to the driving unit.

5. The light emitting diode driving apparatus of claim 4, wherein the noise current limiting unit includes a noise current limiting switch connected between the light emitting diode and the driving unit and conducted by receiving a predetermined power input from the power supplying unit to a gate thereof.

6. The light emitting diode driving apparatus of claim 5, wherein the noise current limiting unit provides a conduction path of a noise current generated due to a parasitic capacitance of the noise current limiting switch.

7. The light emitting diode driving apparatus of claim 6, wherein the noise current limiting unit provides the noise current generated due to the parasitic capacitance of the noise current limiting switch to the power supplying unit.

8. The light emitting diode driving apparatus of claim 4, wherein the noise current limiting unit includes:
a noise current limiting switch connected between the light emitting diode and the driving unit; and
a limitation driving controlling unit receiving the operation power and comparing the detection voltage at which the current flowing to the light emitting diode by the conduction of the switching unit is detected and the preset reference voltage with each other to control driving of the noise current limiting switch.

9. The light emitting diode driving apparatus of claim 8, wherein a conduction period of the noise current limiting switch is equal to or longer than a conduction period of the switching unit.

10. A light emitting diode lighting apparatus comprising:
a dimmer controlling a phase of alternating current power;
a power supplying unit receiving the phase-controlled power from the dimmer and supplying operation power having a preset level;
a light emitting diode unit receiving the phase-controlled power;
a driving unit receiving the operation power from the power supplying unit to drive the light emitting diode unit; and
a noise current limiting unit decreasing a noise current generated due to a parasitic capacitance component of the driving unit.
